(19) United States
(12) Patent Application Publication
(10) Pub. No.: US 2007/0134986 A1
(43) Pub. Date: Jun. 14, 2007

(54) Active enclosure for use in power over ethernet powered device

(75) Inventor: Steven M. Hemmah, Goffstown, NH (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/302,559

(22) Filed: Dec. 13, 2005

(51) Int. Cl. H01R 13/66

(52) U.S. Cl. 439/620.21

(57) ABSTRACT

An active receptacle for use in a RJ-45 connector configured to receive power from an Ethernet Solution.

### FIELD OF THE INVENTION

The present invention is generally related to the field of connectors and more particularly to RJ-45 connectors.

### BACKGROUND OF THE INVENTION

Connectors are adapted to provide physical and electrical interconnection between devices. RJ-45-type connectors are defined by Ethernet IEEE 802.3 standards, and include many types including Category 3, 5, 6 and others.

Conventionally, active power management of power delivered across passive RJ-45 connectors and associated cables is provided by a power management IC solution on a separate printed circuit board (PCB). Disadvantageously, this solution requires space on the PCB and increases the PCB size, which already is significant to provide other-valued features.

### SUMMARY OF INVENTION

The present invention achieves technical advantages as an active RJ-45 receptacle, such as for use in Ethernet solutions providing power to a target device of an Ethernet connection.

### BRIEF DESCRIPTION OF THE DRAWINGS

FIG. 1 depicts an RJ-45 male receptacle according to one preferred embodiment of the invention.

FIG. 2 depicts an RJ-45 female receptacle according to a second preferred embodiment of the invention.

### DETAILED DESCRIPTION OF THE PRESENT INVENTION

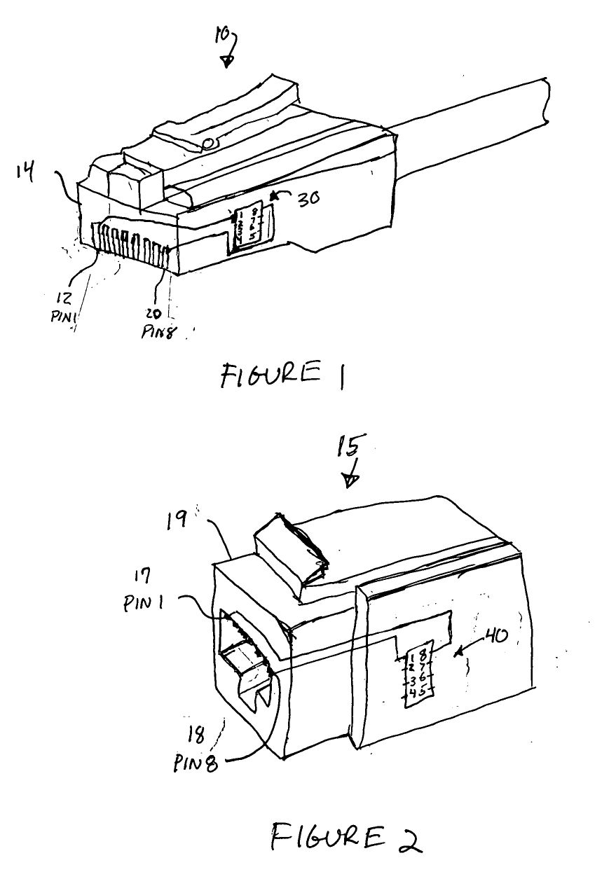

Referring now to FIG. 1, there is shown an active male RJ-45 receptacle 10 including at least one first electrical contact 12 mounted in a receptacle housing 14 and arranged for detachable connection with corresponding electrical contacts of at least one cable assembly or plug, such as another RJ-45 type connector or other compatible connector. Receptacle 10 includes at least one second electrical contact 20 mounted in the receptacle housing 14 and arranged for connection with corresponding electrical contacts of Ethernet network equipment, (not shown). Advantageously, receptacle 10 further includes active power control circuitry 30 located within the receptacle housing 10 and coupled to at least some of the first electrical contacts 12 and second electrical contacts 20. The active power control circuitry 30 is configured and operative for controlling the supply of electrical power delivered to a device receiving power from an Ethernet solution over the network cabling.

The active male RJ-45 connector 10 is configured to manage functions including: voltage, current, power, over-current protection, low-power bus-powered functions, high-power bus-powered functions, self-powered functions, voltage drop budget, power control during suspend/resume, dynamic attach and detach, LED drivers, and inrush current limiting.

The active male connector 10 may be applied to at least one Ethernet node in Ethernet System as defined by Ethernet Standards as additional attachment points within the Ethernet network. The active RJ-45 receptacle 10 may be applied to at least one Ethernet node in functions as defined by Ethernet Standards as functions, which provide capabilities to the system.

The active male RJ-45 connector 10 advantageously manages the power distribution to the device powered from an Ethernet solution such as at least one Ethernet node over the Ethernet network that deals with the issues of how Ethernet powered devices consume power provided by the host over the Ethernet. The active RJ-45 connector 10 also advantageously manages the power management to at least one Ethernet node that deals with how the Ethernet network software and devices fit into the host-based power management system.

Referring now to FIG. 2, there is shown an active female RJ-45 receptacle 15 including at least one first electrical contact 17 mounted in a receptacle housing 19 and arranged for detachable connection with corresponding electrical contacts of at least one cable assembly or plug, such as another RJ-45 type connector or other compatible connector. Receptacle 15 includes at least one second electrical contact 18 mounted in the receptacle housing 15 and arranged for connection with corresponding electrical contacts of Ethernet network equipment, (not shown). Advantageously, receptacle 15 further includes active power control circuitry 40 located within the receptacle housing 19 and coupled to at least some of the first electrical contacts 17 and second electrical contacts 18. The active power control circuitry 40 is configured and operative for controlling the supply of electrical power delivered to a device receiving power from an Ethernet solution over the network cabling.

The active female RJ-45 connector 15 is configured to manage functions including: voltage, current, power, over-current protection, low-power bus-powered functions, high-power bus-powered functions, self-powered functions, voltage drop budget, power control during suspend/resume, dynamic attach and detach, LED drivers, and inrush current limiting.

The active female connector 15 may be applied to at least one Ethernet node in Ethernet System as defined by Ethernet Standards as additional attachment points within the Ethernet network. The active RJ-45 receptacle 15 may be applied to at least one Ethernet node in functions as defined by Ethernet Standards as functions, which provide capabilities to the system.

The active female RJ-45 connector 15 advantageously manages the power distribution to the device powered from an Ethernet solution such as at least one Ethernet node over the Ethernet network that deals with the issues of how Ethernet powered devices consume power provided by the host over the Ethernet. The active RJ-45 connector 15 also advantageously manages the power management to at least one Ethernet node that deals with how the Ethernet network software and devices fit into the host-based power management system.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A receptacle, comprising:
a housing;
first and second electrical contacts configured to receive electrical signals from an Ethernet compliant device; and
an active power management circuit disposed in the housing and coupled to the first and second electrical contacts, the circuit being configured to manage power delivered through the receptacle from an Ethernet solution.

2. The receptacle as specified in claim 1 wherein the active power management circuit comprise an integrated circuit (IC).

3. The receptacle as specified in claim 2 wherein the receptacle is a male RJ-45 receptacle.

4. The receptacle as specified in claim 2 wherein the receptacle is a female RJ-45 receptacle.

5. The receptacle as specified in claim 2 wherein the receptacle is configured as an Ethernet network.
